(19) United States
(12) Patent Application Publication
(10) Pub. No.: US 2026/0145634 A1
(43) Pub. Date: May 28, 2026

(54) AIRBAG DEVICE

(71) Applicant: TOYODA GOSEI CO., LTD., Kiyosu-shi (JP)

(72) Inventors: Atsushi KASHIO, Aichi (JP); Ryoichi KATO, Aichi (JP); Ken NITAYAMA, Aichi (JP)

(21) Appl. No.: 19/398,999

(22) Filed: Nov. 24, 2025

(30) Foreign Application Priority Data
Nov. 26, 2024 (JP) 2024-205744

(51) Int. Cl. B60R 21/213; B60R 21/237; B60R 21/268

(52) U.S. Cl. CPC B60R 21/213; B60R 21/237; B60R 21/268

(57) ABSTRACT

An airbag device is mounted on a vehicle including a front window, a front pillar, a hood panel, and a cowl top panel having a protrusion. The airbag device has an airbag which is folded and stored inside the vehicle, and an inflator which discharges an inflation gas to be supplied to the airbag. The airbag is delivered outside the vehicle from a gap between the hood panel and the cowl top panel while being inflated and deployed by being supplied with the inflation gas, is deployed rearward to abut against and ride over the protrusion, and covers at least a part of the front pillar from above at a time of full inflations. An abutting portion of the airbag that is abutted against the protrusion during the deployment from a folded state is roll-folded in a state where the airbag is folded.

### CROSS-REFERENCE TO RELATED APPLICATIONS

This application is based on and claims priority under 35 USC 119 from Japanese Patent Application No. 2024-205744 filed on November 26, 2024, the entire content of which is incorporated herein by reference.

### TECHNICAL FIELD

The present disclosure relates to an airbag device that is to be mounted on a vehicle and receives and protects a person such as a pedestrian outside the vehicle with an airbag.

### BACKGROUND ART

In the related art, an airbag device is known in which an airbag is deployed from a vicinity of a rear end of a hood panel during a collision of a vehicle, and a pedestrian or the like outside the vehicle that is about to collide violently with a pillar of the vehicle is received and protected by the airbag, as in a configuration described in JP2018-172008A. The airbag is configured to be stored inside the vehicle in a folded state before inflation is started. The airbag is configured to be inflated and deployed by being supplied with an inflation gas during the collision of the vehicle or the like, and to be delivered outside the vehicle, and to cover the pillar of the vehicle at a time of full inflation.

In JP2018-172008A, the airbag before inflation is entirely accordion-folded and stored inside the vehicle. The accordion-folded portion of the airbag tends to deploy linearly when the airbag is supplied with the inflation gas and inflated.

In the vehicle, a cowl top panel is provided between a front window and the hood panel. The cowl top panel may be provided with a protrusion that protrudes upward in order to prevent rainwater from entering inside the vehicle from a gap between the hood panel and the cowl top panel.

Here, in a case where the protrusion is provided on the cowl top panel and the entire airbag is accordion-folded as in JP2018-172008A, the airbag is linearly deployed when being inflated and may be caught by the protrusion of the cowl top panel. In this case, the airbag may be deployed with unintended behavior, and a timing at which the airbag covers a front pillar may be delayed.

### SUMMARY OF INVENTION

An object of the present disclosure is to provide an airbag device capable of preventing an airbag from being caught by a protrusion of a cowl top panel during deployment.

An aspect of the present disclosure relates to an airbag device to be mounted on a vehicle including a front window, front pillars disposed on both sides of the front window in a left-right direction, a hood panel disposed in front of the front window, and a cowl top panel disposed between the front window and the hood panel in a front-rear direction and including a protrusion that protrudes upward, the airbag device having: an airbag configured to be folded and stored inside the vehicle, in which the airbag is delivered outside the vehicle from a gap between the hood panel and the cowl top panel while being inflated and deployed by being supplied with an inflation gas, is deployed rearward to abut against and ride over the protrusion, and covers at least a part of each of the front pillars from above at a time of full inflation; and an inflator configured to discharge the inflation gas to be supplied to the airbag, in which an abutting portion of the airbag that is abutted against the protrusion during the deployment from a folded state is roll-folded in a state where the airbag is folded.

According to the airbag device of the aspect of the present disclosure, the airbag can be prevented from being caught by the protrusion of the cowl top panel during the deployment.

### BRIEF DESCRIPTION OF DRAWINGS

Exemplary embodiment(s) of the present invention will be described in detail based on the following figures, wherein:

FIG. 1 is a schematic plan view of a vehicle equipped with an airbag device;

FIG. 2 is a schematic plan view of the vehicle showing a state where airbags of the airbag device are fully inflated;

FIG. 3 is a schematic cross-sectional view of the vehicle taken along line A1-A1 in FIG. 1;

FIG. 4 is a schematic cross-sectional view of the vehicle taken along line A2-A2 in FIG. 2;

FIG. 5 is a perspective view of a periphery of a gas discharge port of the vehicle with the airbag inflated;

FIG. 6 is a perspective view of the periphery of the gas discharge port of the vehicle

with the airbag inflated;

FIG. 7 is a developed view in which the airbag before inflation is deployed flat;

FIG. 8 is a schematic view showing a method of folding the airbag;

FIG. 9 is a schematic view and a schematic cross-sectional view showing the method of folding the airbag;

FIG. 10 is a schematic view showing behavior of the airbag during deployment;

FIG. 11 is a schematic view showing the method of folding the airbag;

FIG. 12 is a schematic view showing the method of folding the airbag;

FIG. 13 is a schematic view showing the method of folding the airbag;

FIG. 14 is a schematic view showing the behavior of the airbag during deployment; and

FIG. 15 is a schematic cross-sectional view showing the method of folding the airbag.

### DESCRIPTION OF EMBODIMENTS

### (First Embodiment)

Hereinafter, an airbag device 10 according to a first embodiment of the present disclosure will be described with reference to the drawings. Dimensions, materials, shapes and the like of the components described below are not intended to limit the scope of the present invention to those described below, unless otherwise specified.

The airbag device 10 is mounted on a vehicle 50, and receives and protects a person such as a pedestrian M outside the vehicle 50 with airbags 30, 40. In the following description, unless otherwise specified, a left-right direction means a left direction and a right direction with reference to the vehicle 50, a front-rear direction means a front direction and a rear direction with reference to the vehicle 50, and an upper-lower direction means an upper direction and a lower direction in a vertical direction. That is, the left-right direction means a vehicle width direction of the vehicle 50, and the front-rear direction means a forward direction or a backward direction when the vehicle 50 travels straight.

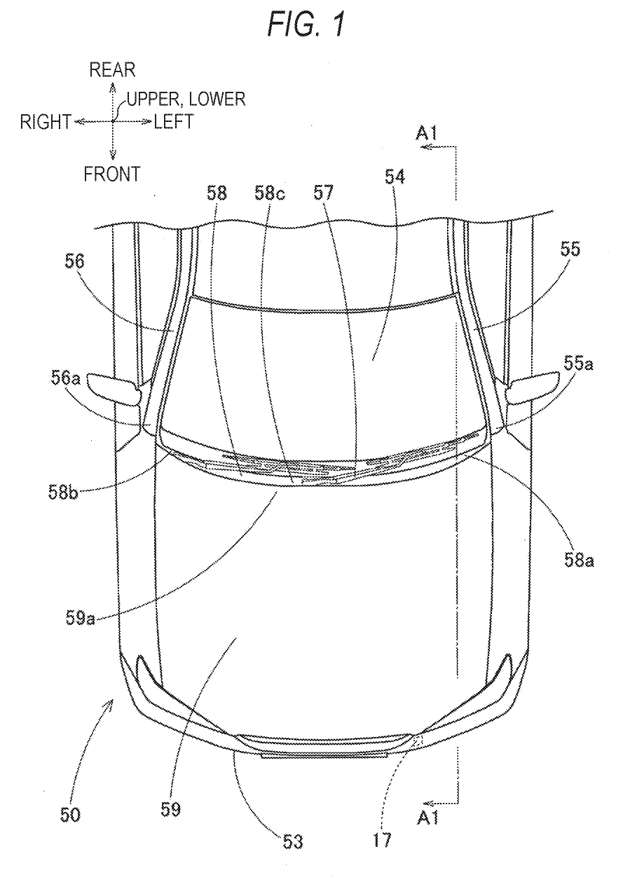

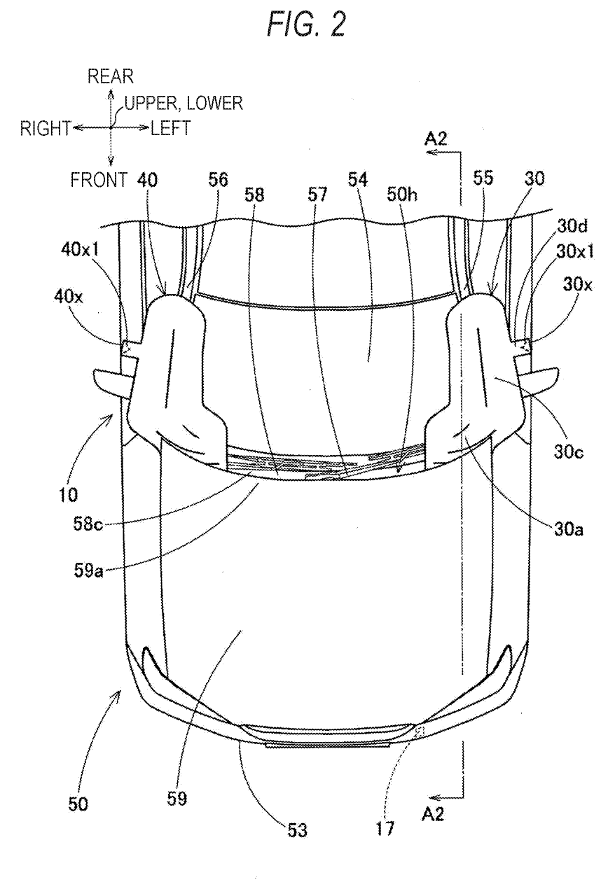

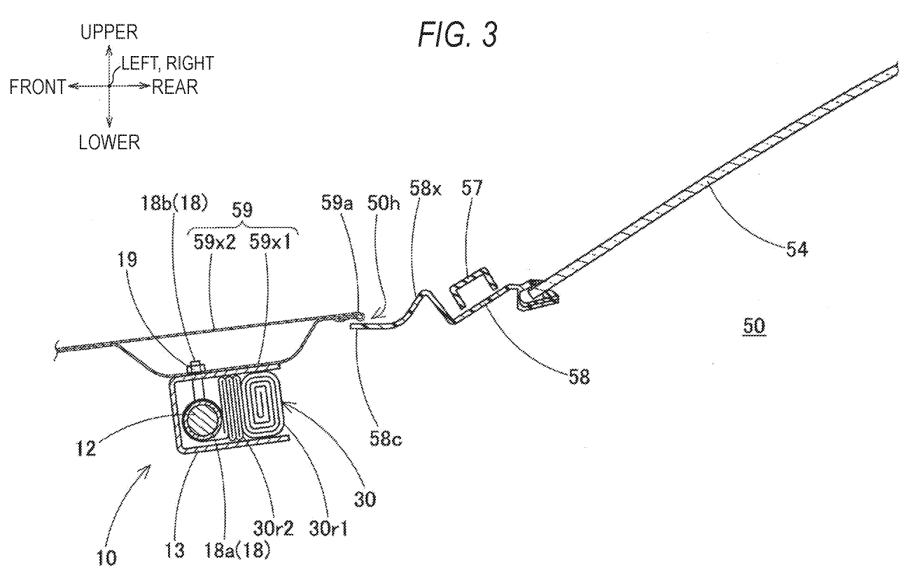

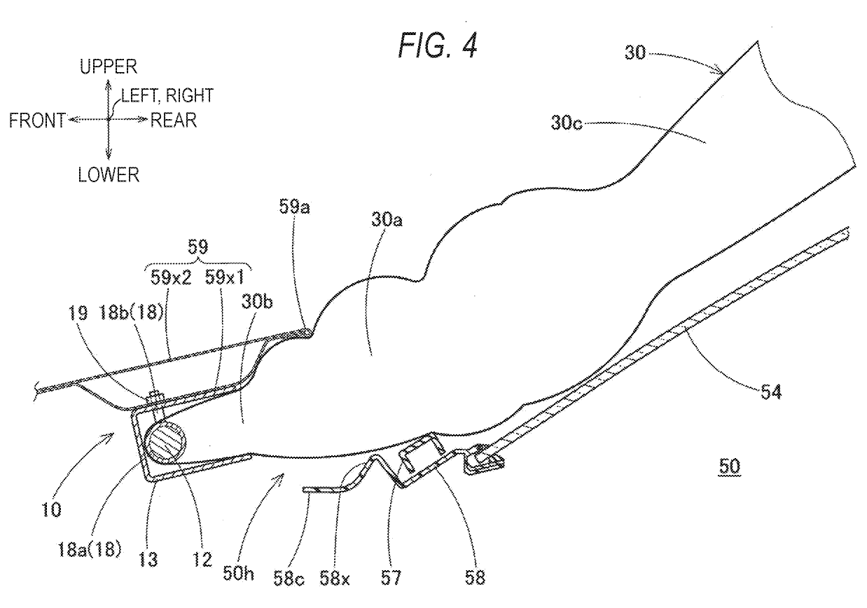

FIG. 1 is a schematic plan view of the vehicle 50 equipped with the airbag device 10. FIG. 2 is a schematic plan view of the vehicle 50 showing a state where the airbags 30, 40 of the airbag device 10 are fully inflated. FIG. 3 is a schematic cross-sectional view of the vehicle 50 taken along line A1-A1 in FIG. 1. FIG. 4 is a schematic cross-sectional view of the vehicle 50 taken along line A2-A2 in FIG. 2.

As shown in FIGS. 1 to 4, the vehicle 50 includes, in a front portion thereof, a front window 54, a hood panel 59 covering an engine room (not shown), and a cowl top panel 58 disposed between the front window 54 and the hood panel 59 in the front-rear direction. Further, the vehicle 50 includes a left front pillar 55 disposed on a left side of the front window 54 and a right front pillar 56 disposed on a right side of the front window 54.

The hood panel 59 includes two panels, including an inner panel 59x1 disposed on a vehicle inner side and an outer panel 59x2 disposed on a vehicle outer side. In a normal state where the airbag device 10 is not operated, a rear end portion 59a of the hood panel 59 is disposed slightly above a front end portion 58c of the cowl top panel 58, thereby a minute gap 50h is provided between the rear end portion 59a of the hood panel 59 and the front end portion 58c of the cowl top panel 58. Further, the cowl top panel 58 is provided with a protrusion 58x that protrudes upward in order to prevent rainwater from entering inside the vehicle 50 through the gap 50h. A wiper 57 for scraping off water droplets adhering to the front window 54 is attached to an upper surface of the cowl top panel 58.

The airbag device 10 includes the airbag 30 mounted on a left side of the vehicle 50, an inflator 12 that discharges an inflation gas to be supplied to the airbag 30, and a case 13 that accommodates the airbag 30 in a folded state. Further, the airbag device 10 includes the airbag 40 mounted on a right side of the vehicle 50, an inflator (not shown) that discharges inflation gas to be supplied to the airbag 40, and a case (not shown) that accommodates the airbag 40 in a folded state.

Here, the airbag 40, the inflator that supplies the inflation gas to the airbag 40, and the case that accommodates the airbag 40 have the same configuration as the airbag 30, the inflator 12, and the case 13, and are attached to the vehicle 50 by the same attachment configuration, and operate symmetrically. Therefore, hereinafter, the airbag 30, the inflator 12, and the case 13 will be described in detail, and the description of the airbag 40, the inflator that supplies the inflation gas to the airbag 40, and the case that accommodates the airbag 40 will be omitted as appropriate.

Further, the airbag device 10 includes an acceleration sensor 17 used for detecting a collision of the vehicle 50, an actuator (not shown) that lifts the rear end portion 59a of the hood panel 59 upward, the inflator 12 and an inflator (not shown) that supplies the inflation gas to the airbag 40 according to a detection result of the acceleration sensor 17, and a control device (not shown) that controls an operation of the actuator.

The acceleration sensor 17 is attached to a front bumper 53 of the vehicle 50, and detects an impact caused by a collision or the like of the vehicle 50 as acceleration. The control device (not shown) includes a CPU, a memory, and the like, and is attached to a predetermined position inside the vehicle 50. The control device is electrically connected to the inflator 12, the inflator (not shown) that supplies the inflation gas to the airbag 40, and the actuator (not shown), and transmits an operation signal to these members according to the detection result of the acceleration sensor 17.

The inflator 12 is a substantially columnar member disposed inside the airbag 30, and has, at one end portion thereof in the left-right direction, a gas discharge port (not shown) for discharging the inflation gas. The inflator 12 is operated when an operation signal is received from the control device (not shown) so as to generate the inflation gas, and discharges the inflation gas from the gas discharge port to supply the inflation gas into the airbag 30.

Further, the inflator 12 is attached to the inner panel 59x1 of the hood panel 59 together with the airbag 30 and the case 13 by a bolted clamp 18 made of metal. Specifically, the bolted clamp 18 includes an annular clamp portion 18a that can be reduced in diameter, and a bolt portion 18b that protrudes upward from an outer peripheral surface of the clamp portion 18a. The clamp portion 18a is wound around an outer periphery of the inflator 12. The bolt portion 18b is inserted into screw holes (not shown) formed in the airbag 30, the case 13, and the inner panel 59x1 in a state where the clamp portion 18a is wound around the inflator 12, and is fastened by a nut 19. By fastening the nut 19, the clamp portion 18a is reduced in diameter to hold the inflator 12, and the inflator 12, the airbag 30, and the case 13 are integrally fixed to the inner panel 59x1.

The airbag 30 is a bag-shaped member, is stored in the case 13 inside the vehicle 50 in a folded state before the inflation gas is supplied, and is delivered outside the vehicle 50 while being inflated and deployed from the folded state when the inflation gas is supplied to an inside. In the present embodiment, the airbag 30 is formed by a bag-shaped woven fabric made of polyester yarn.

The airbag 30 at a time of full inflation includes a cowl cover portion 30a that is disposed outside the vehicle 50 and is wide in the left-right direction to cover a periphery of a left end portion 58a of the cowl top panel 58 and a periphery of the front end portion 55a of the left front pillar 55 from above, and a connection portion 30b that is disposed inside the vehicle 50 and connects a portion accommodating the inflator 12 and the cowl cover portion 30a. The airbag 30 at the time of full inflation includes a pillar cover portion 30c that extends rearward from the cowl cover portion 30a and is wide in the front-rear direction to cover substantially an entire region of the left front pillar 55 other than the front end portion 55a from above, and a gas discharge portion 30d that extends leftward from a left end portion of the pillar cover portion 30c. A tip end portion of the gas discharge portion 30d is a gas discharge port 30x that is opened when a predetermined external pressure or more is applied to the airbag 30 after the airbag 30 is fully inflated, and discharges excess inflation gas inside the airbag 30 to the outside.

The case 13 is a substantially rectangular parallelepiped box-shaped member made of sheet metal and having a rear surface that is opened. As described above, the case 13 is fixed to the inner panel 59x1 of the hood panel 59 by the bolted clamp 18. In the present embodiment, although the case 13 having the rear surface opened in advance is used, in order to protect the airbag 30 from rainwater or the like, a configuration may be adopted in which when the airbag 30 is inflated, the airbag 30 is pressed and the rear surface is deformed or broken to form an opening, and the airbag 30 is delivered outside the case 13 from the opening.

Next, an operation of protecting the pedestrian M with the airbag device 10 will be described. First, when the vehicle 50 collides with the pedestrian M, the acceleration sensor 17 detects the collision as the acceleration. When the acceleration detected by the acceleration sensor 17 is equal to or greater than a predetermined value, the control device (not shown) determines that the vehicle 50 has collided, and transmits an operation signal to the inflator 12, the inflator (not shown) that supplies the inflation gas to the airbag 40, and the actuator (not shown).

Next, the actuator operated when receiving the operation signal lifts the rear end portion 59a of the hood panel 59 upward. Accordingly, the gap 50h between the hood panel 59 and the cowl top panel 58 of the vehicle 50 is widened. Further, the inflator 12 operated when receiving the operation signal supplies the inflation gas into the airbag 30. Similarly, the inflator (not shown) operated when receiving the operation signal supplies the inflation gas into the airbag 40.

Next, the airbag 30 started to be inflated by being supplied with the inflation gas is deployed from the folded state and delivered outside the vehicle 50 through the gap 50h. Then, the airbag 30 is deployed rearward to ride over the protrusion 58x of the cowl top panel 58. Thereafter, when the inflation gas is further supplied to the airbag 30, the airbag 30 is fully inflated to cover the periphery of the left end portion 58a of the cowl top panel 58 of the vehicle 50 and substantially the entire region of the left front pillar 55 from above, and the inflation is completed.

Similarly, the airbag 40 started to be inflated by being supplied with the inflation gas is deployed from the folded state and is delivered outside the vehicle 50 through the gap 50h. Then, the airbag 30 is deployed rearward to ride over the protrusion 58x of the cowl top panel 58. Next, when the inflation gas is further supplied to the airbag 40, the airbag 40 is fully inflated to cover a periphery of a right end portion 58b of the cowl top panel 58 of the vehicle 50 and substantially an entire region of the right front pillar 56 from above, and the inflation is completed. Thereafter, the pedestrian M who collides with the vehicle 50 to be flipped up and is about to collide violently with the cowl top panel 58, the left front pillar 55, or the right front pillar 56 is received and protected by the airbag 30 or the airbag 40.

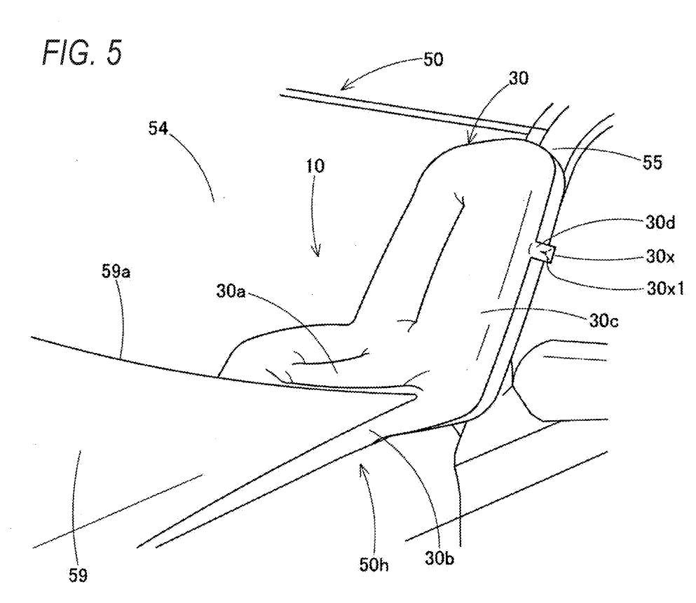

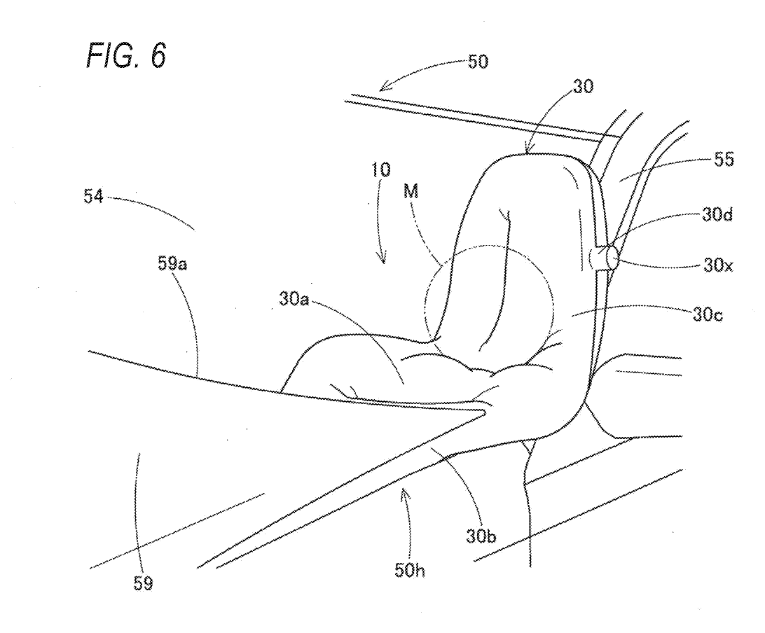

Further, as shown in FIG. 5, the gas discharge port 30x of the airbag 30 is sealed by sewing the airbag 30 at a temporary sewn portion 30x1 during a period until a predetermined external pressure or more is applied after the airbag 30 is fully inflated. As shown in FIG. 6, after the airbag 30 is fully inflated, when a predetermined external pressure or more is applied to the airbag 30 while the airbag 30 is receiving the pedestrian M, the sewing of the temporary sewn portion 30x1 is released to open the gas discharge port 30x.

Similarly, a gas discharge port 40x of the airbag 40 is sealed by sewing the airbag 40 at a temporary sewn portion 40x1 during a period until a predetermined external pressure or more is applied to the airbag 40 after the airbag 40 is fully inflated. After the airbag 40 is fully inflated, when a predetermined external pressure or more is applied to the airbag 40 while the airbag 40 is receiving the pedestrian M, the sewing of the temporary sewn portion 40x1 is released to open the gas discharge port 40x.

In this way, in the airbags 30, 40, the internal pressure is maintained without discharging the inflation gas from the gas discharge ports 30x, 40x to the outside during a period until the pedestrian M is received, and after the pedestrian M is received, the gas discharge ports 30x, 40x are opened to discharge the inflation gas to reduce the internal pressure. Accordingly, the pedestrian M is received by the airbags 30, 40 in each of which a high reaction force is maintained, and is prevented from colliding violently with a ground or the like by being flipped up by the reaction force of the airbags 30, 40.

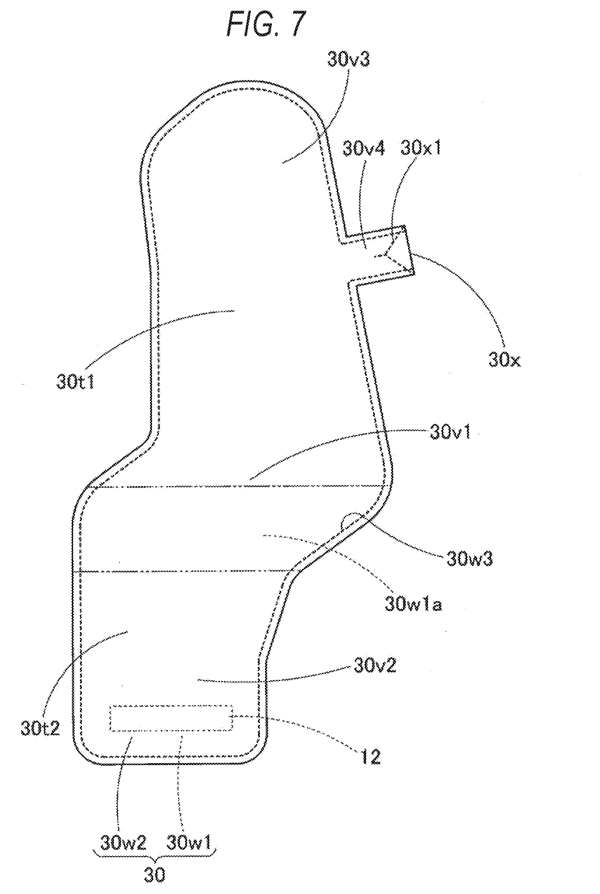

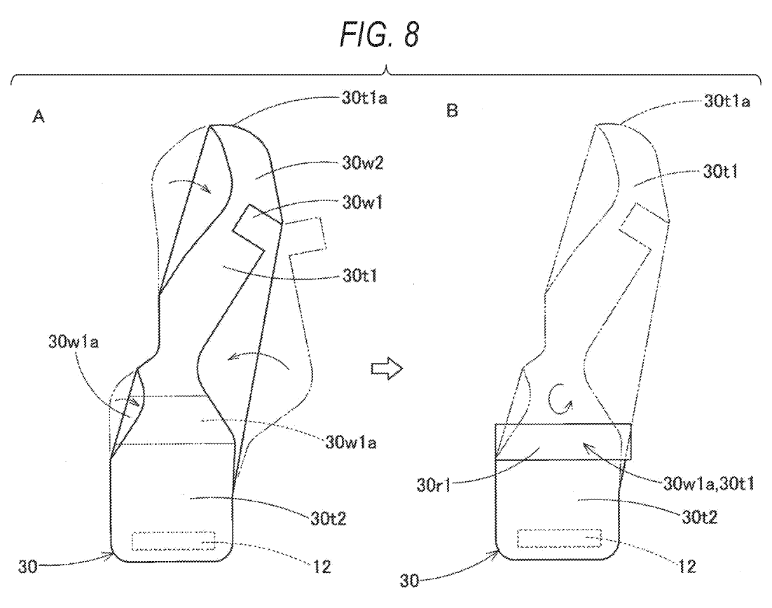

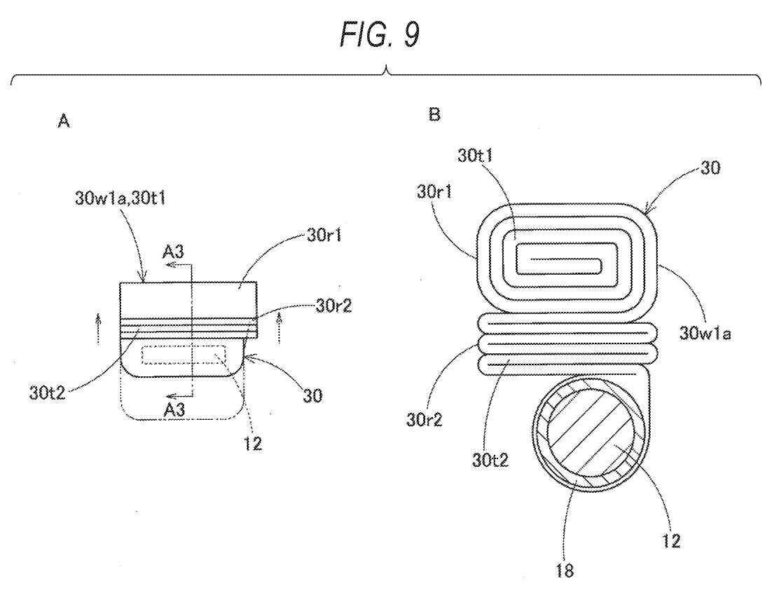

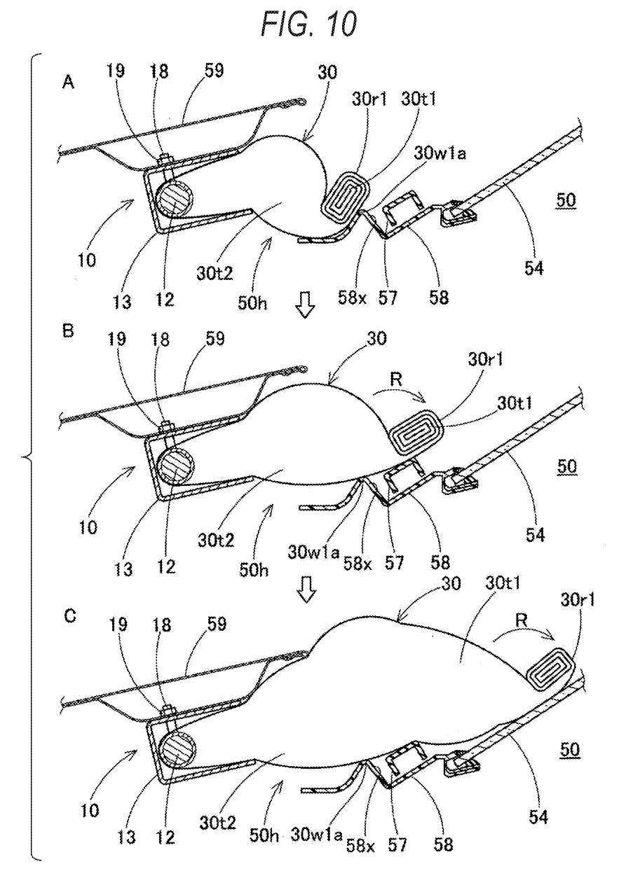

Next, a detailed configuration of the airbag 30 will be described. FIG. 7 is a developed view in which the airbag 30 before inflation is deployed flat. FIG. 8 and section A of FIG. 9 are schematic views sequentially illustrating a method of folding the airbag 30. Section B of FIG. 9 is a schematic cross-sectional view of the airbag 30 taken along line A3-A3 shown in section A of FIG. 9. FIG. 10 is a schematic view showing behavior of the airbag 30 during the deployment.

As shown in FIG. 7, the airbag 30 is formed in a bag shape by sewing, at a sewn portion 30w3, an outer peripheral edge of an inner panel 30w1 constituting a lower surface of the airbag 30 at the time of full inflation and an outer peripheral edge of an outer panel 30w2 constituting an upper surface of the airbag 30 at the time of full inflation. It can be said that the inner panel 30w1 constitutes a surface of the airbag 30 facing the cowl top panel 58 and the left front pillar 55 at the time of full inflation. Further, it can be said that the outer panel 30w2 is a panel that is disposed above the inner panel 30w1 in the airbag 30 at the time of full inflation and constitutes a surface that receives the pedestrian M.

The airbag 30 deployed flat includes a cowl cover forming portion 30v1 that forms the cowl cover portion 30a when inflated, a connection forming portion 30v2 that forms the connection portion 30b, a pillar cover forming portion 30v3 that forms the pillar cover portion 30c, and a gas discharge forming portion 30v4 that forms the gas discharge portion 30d. Further, inside the airbag 30, a plurality of tethers (not shown) are provided in each of which one end portion and the other end portion are respectively sewn to the inner panel 30w1 and the outer panel 30w2 to regulate a thickness of the airbag 30 at the time of full inflation.

Further, in the airbag 30, the outer peripheral edge of the inner panel 30w1 and the outer peripheral edge of the outer panel 30w2 are partially unsewn together at the sewn portion 30w3, and the unsewn portion serves as the gas discharge port 30x of the airbag 30. As described above, the gas discharge port 30x is sealed at the temporary sewn portion 30x1 until a predetermined external pressure or more is applied to the airbag 30 after the airbag 30 is fully inflated. The temporary sewn portion 30x1 is a portion where the inner panel 30w1 and the outer panel 30w2 are sewn together to seal the gas discharge port 30x in a periphery of the gas discharge port 30x. After the airbag 30 is fully inflated, when a predetermined external pressure or more is applied to the airbag 30 while the airbag 30 is receiving the pedestrian M, the airbag 30 is deformed, the internal pressure increases, accordingly a sewing thread of the temporary sewn portion 30x1 breaks, the thread comes off, and the sewing of the temporary sewn portion 30x1 is released. Accordingly, the gas discharge port 30x is opened.

The inner panel 30w1 of the airbag 30 includes a cowl abutting portion 30w1a (abutting portion) that is abutted against the protrusion 58x of the cowl top panel 58 when the airbag 30 is supplied with the inflation gas from the inflator 12 and inflated and deployed from the folded state. In the present embodiment, the cowl abutting portion 30w1a is a portion defined by two two-dot chain lines in the inner panel 30w1 of the airbag 30 deployed flat as shown in FIG. 7.

In the airbag 30 deployed flat as shown in FIG. 7, a portion above the cowl abutting portion 30w1a on a paper surface of FIG. 7 is a portion disposed rearward than the cowl abutting portion 30w1a at the time of full inflation, and is referred to as a rear inflation portion 30t1 in the following description. In the airbag 30 deployed flat as shown in FIG. 7, a portion below the cowl abutting portion 30w1a on the paper surface of FIG. 7 is a portion disposed forward than the cowl abutting portion 30w1a at the time of full inflation, and is referred to as a front inflation portion 30t2 in the following description. The inflator 12 is accommodated in the front inflation portion 30t2.

Next, a method of folding the airbag 30 when the airbag 30 is stored inside the vehicle 50 will be described. As shown in section A of FIG. 8, when folding the airbag 30, an operator first folds end portions in the left-right direction of the airbag 30 deployed flat inward to make a width of the entire airbag 30 in the left-right direction uniform. The operator starts to fold the airbag 30 in a state where the airbag 30 is placed such that the outer panel 30w2 is disposed on the upper side and the inner panel 30w1 is disposed on the lower side.

Next, as shown in section B of FIG. 8, the operator roll-folds the rear inflation portion 30t1 and the cowl abutting portion 30w1a from an end portion 30t1a of the rear inflation portion 30t1 of the airbag 30 toward the front inflation portion 30t2 such that the outer panel 30w2 is disposed inside, thereby forming a roll-folded portion 30r1 in the airbag 30. That is, the roll-folded portion 30r1 is a portion in which the rear inflation portion 30t1 and the cowl abutting portion 30w1a are integrally roll-folded in the airbag 30 in the folded state before the inflation is started. In other words, the roll-folded portion 30r1 includes the rear inflation portion 30t1 and the cowl abutting portion 30w1a.

Next, as shown in section A of FIG. 9, the operator accordion-folds a portion in the front inflation portion 30t2 of the airbag 30, which is closer to the roll-folded portion 30r1 than a portion in which the inflator 12 is accommodated, toward the roll-folded portion 30r1, thereby forming an accordion-folded portion 30r2 in the airbag 30. Thereafter, the operator fixes the roll-folded portion 30r1 and the accordion-folded portion 30r2 together with a tape (not shown) to prevent the folding from collapsing. In this way, the airbag 30 is folded and mounted on the vehicle 50. When the airbag 30 is inflated, the tape (not shown) is pressurized by the airbag 30 and is broken, which does not adversely affect the deployment of the airbag 30.

By folding the airbag 30 as described above, the airbag 30 is deployed as follows when inflated. That is, when the inflation gas is discharged from the inflator 12, the inflation gas is first supplied to the accordion-folded portion 30r2 in which the front inflation portion 30t2 is folded in the airbag 30. Accordingly, as shown in section A of FIG. 10, the accordion-folded portion 30r2 is inflated and deployed linearly rearward, and the roll-folded portion 30r1 located rearward of the accordion-folded portion 30r2 is abutted against the protrusion 58x of the cowl top panel 58. Specifically, the cowl abutting portion 30w1a of the airbag 30 included in the roll-folded portion 30r1 is abutted against the protrusion 58x of the cowl top panel 58.

Next, when the inflation gas is further discharged from the inflator 12, the inflation gas reaches the roll-folded portion 30r1 of the airbag 30. Accordingly, as shown in section B of FIG. 10, the roll-folded portion 30r1 is inflated and gradually deployed while rotating (rotating rearward) in an arrow R direction to release the roll-folding. At this time, the airbag 30 rides over the protrusion 58x of the cowl top panel 58 due to the rotation of the roll-folded portion 30r1. Thereafter, as shown in section C of FIG. 10, when the inflation gas is further discharged from the inflator 12, the roll-folded portion 30r1 is similarly inflated and deployed while being gradually rotated, and finally the airbag 30 is fully inflated.

In this way, in the airbag 30 of the present embodiment, the cowl abutting portion 30w1a that is abutted against the protrusion 58x of the cowl top panel 58 during the deployment from the folded state is roll-folded in a state where the airbag 30 is folded. Accordingly, after the cowl abutting portion 30w1a is abutted against the protrusion 58x of the cowl top panel 58, the airbag 30 can climb over the protrusion 58x when the roll-folded portion 30r1 including the cowl abutting portion 30w1a is deployed while rotating to release the roll-folding. Therefore, according to the airbag device 10 of the present embodiment, the airbag 30 can be prevented from being caught by the protrusion 58x of the cowl top panel 58 during the deployment. Therefore, the left front pillar 55 can be quickly covered by the airbag 30.

In the state where the airbag 30 is folded, the front inflation portion 30t2 of the airbag 30 is accordion-folded. Accordingly, the front inflation portion 30t2 can be folded more compactly than in a configuration in which the front inflation portion 30t2 is roll-folded. Therefore, the airbag 30 in the folded state can be downsized. If this point is not taken into consideration, the entire airbag 30 may be roll-folded.

Therefore, the airbag 30 in the folded state can be downsized. If this point is not taken into consideration, the entire airbag 30 may be roll-folded.

### (Second Embodiment)

Next, the airbag device 10 according to a second embodiment of the present disclosure will be described. The same parts as those in the first embodiment are denoted by the same reference numerals, and the description thereof will be omitted.

The airbag device 10 according to the present embodiment is different from the airbag device 10 according to the first embodiment only in the folding method when the airbag 30 is mounted on the vehicle 50. Since other configurations of the airbag device 10 according to the present embodiment are the same as the configurations of the airbag device 10 of the first embodiment, the method of folding the airbag 30 will be mainly described below.

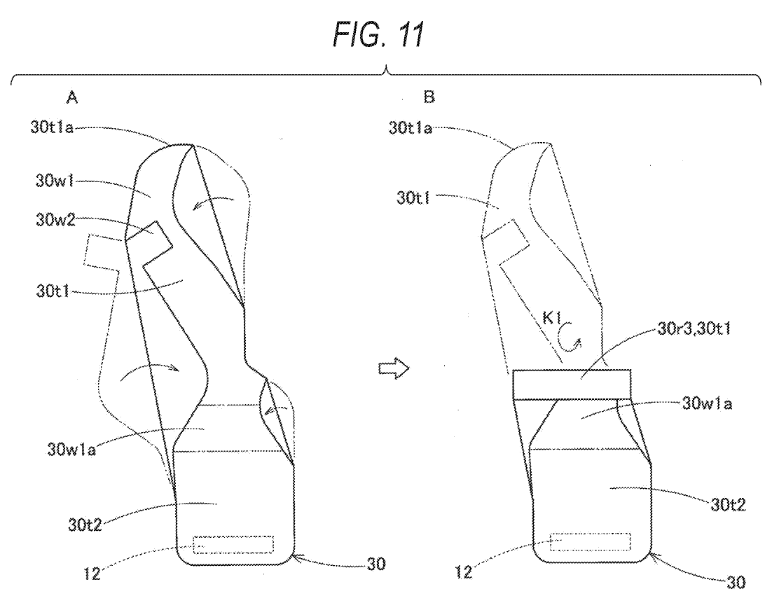

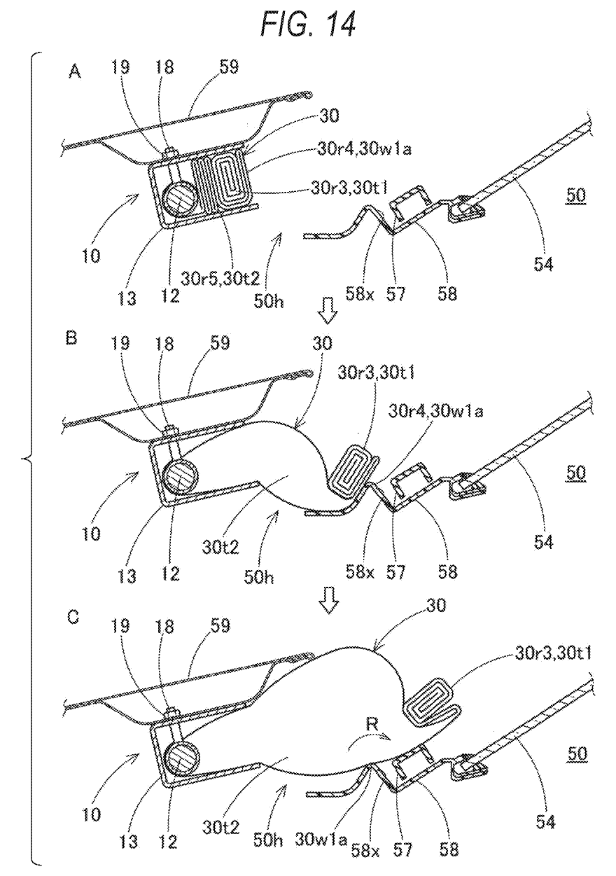

FIGS. 11 to 13 are schematic views sequentially showing the method of folding the airbag 30 according to the present embodiment. FIG. 14 is a schematic view showing behavior of the airbag 30 of the present embodiment during deployment. As shown in section A of FIG. 11, when folding the airbag 30, the operator first folds the end portions in the left-right direction of the airbag 30 deployed flat inward to make a width of the entire airbag 30 in the left-right direction uniform. Unlike the first embodiment, in the present embodiment, the operator starts to fold the airbag 30 in a state where the airbag 30 is placed such that the inner panel 30w1 is disposed on the upper side and the outer panel 30w2 is disposed on the lower side.

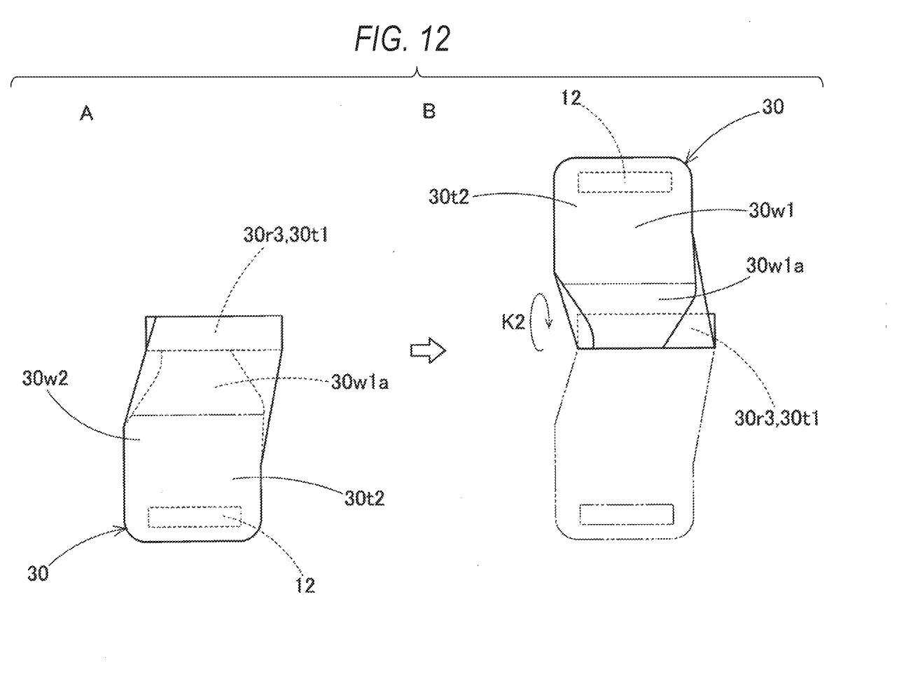

Next, as shown in section B of FIG. 11, the operator roll-folds the rear inflation portion 30t1 from the end portion 30t1a of the rear inflation portion 30t1 of the airbag 30 toward the cowl abutting portion 30w1a such that the inner panel 30w1 is disposed inside. Accordingly, a roll-folded portion 30r3 is formed in the airbag 30. That is, the roll-folded portion 30r3 is a portion where the rear inflation portion 30t1 is roll-folded in the folded airbag 30 before the inflation is started. Next, as shown in section A of FIG. 12, the operator reverses the front and back of the airbag 30 in the state shown in section B of FIG. 11.

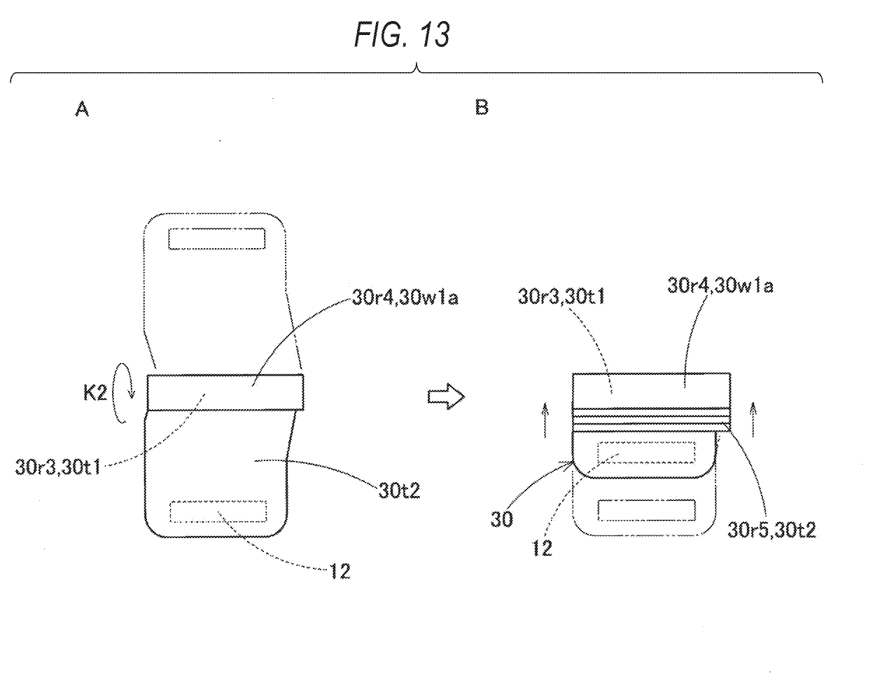

Next, as shown in section B of FIG. 12 and section A of FIG. 13, the operator winds the cowl abutting portion 30w1a of the airbag 30 around an outer periphery of the roll-folded portion 30r3 to form a wound portion 30r4 in the airbag 30. A winding direction K2 of the cowl abutting portion 30w1a of the wound portion 30r4 with respect to the roll-folded portion 30r3 is opposite to a roll direction K1 (section B of FIG. 11) of the roll-folded portion 30r3. That is, the wound portion 30r4 is formed by winding the cowl abutting portion 30w1a of the airbag 30 around the outer periphery of the roll-folded portion 30r3.

Next, as shown in section B of FIG. 13, the operator accordion-folds a portion of the front inflation portion 30t2 of the airbag 30, which is closer to the wound portion 30r4 than a portion in which the inflator 12 is accommodated, toward the roll-folded portion 30r3 and the wound portion 30r4. Accordingly, an accordion-folded portion 30r5 is formed in the airbag 30. Thereafter, the operator fixes the roll-folded portion 30r3, the wound portion 30r4, and the accordion-folded portion 30r5 together with a tape (not shown) to prevent the folding from collapsing. In this way, the airbag 30 is folded and mounted on the vehicle 50. When the airbag 30 is inflated, the tape (not shown) is pressurized by the airbag 30 and is broken, which does not adversely affect the deployment of the airbag 30.

By folding the airbag 30 as described above, the airbag 30 is deployed as follows when inflated. That is, when the inflation gas is discharged from the inflator 12 to the airbag 30 in a state shown in section A of FIG. 14, the inflation gas is first supplied to the accordion-folded portion 30r5 in which the front inflation portion 30t2 is folded in the airbag 30. Accordingly, as shown in section B of FIG. 14, the accordion-folded portion 30r5 is inflated and deployed linearly rearward, and the wound portion 30r4 located rearward of the accordion-folded portion 30r5 is abutted against the protrusion 58x of the cowl top panel 58. In other words, since the wound portion 30r4 is a portion where the cowl abutting portion 30w1a of the airbag 30 is wound around the roll-folded portion 30r3, the cowl abutting portion 30w1a is abutted against the protrusion 58x of the cowl top panel 58.

Next, when the inflation gas is further discharged from the inflator 12, the inflation gas reaches the wound portion 30r4 of the airbag 30. Accordingly, as shown in section C of FIG. 14, the wound portion 30r4 is inflated and deployed while rotating (rotating rearward) in the arrow R direction to release the roll-folding around the roll-folded portion 30r3. At this time, the airbag 30 rides over the protrusion 58x of the cowl top panel 58 due to the rotation of the wound portion 30r4. Thereafter, when the inflation gas is further discharged from the inflator 12, the inflation gas reaches the roll-folded portion 30r3 to gradually deploy the roll-folded portion 30r3, and finally the airbag 30 is fully inflated.

In this way, in the airbag 30 of the present embodiment, the cowl abutting portion 30w1a that is abutted against the protrusion 58x of the cowl top panel 58 during the deployment from the folded state forms the wound portion 30r4 wound around the outer periphery of the roll-folded portion 30r3 in the state where the airbag 30 is folded. Accordingly, after the cowl abutting portion 30w1a is abutted against the protrusion 58x of the cowl top panel 58, the airbag 30 can climb over the protrusion 58x when the wound portion 30r4 is deployed while rotating to release the roll-folding around the roll-folded portion 30r3. Therefore, according to the airbag device 10 of the present embodiment, the airbag 30 can be prevented from being caught by the protrusion 58x of the cowl top panel 58 during the deployment. Therefore, the left front pillar 55 can be quickly covered by the airbag 30.

In the state where the airbag 30 is folded, the front inflation portion 30t2 of the airbag 30 is accordion-folded. Accordingly, the front inflation portion 30t2 can be folded more compactly than in the configuration in which the front inflation portion 30t2 is roll-folded. Therefore, the airbag 30 in the folded state can be downsized.

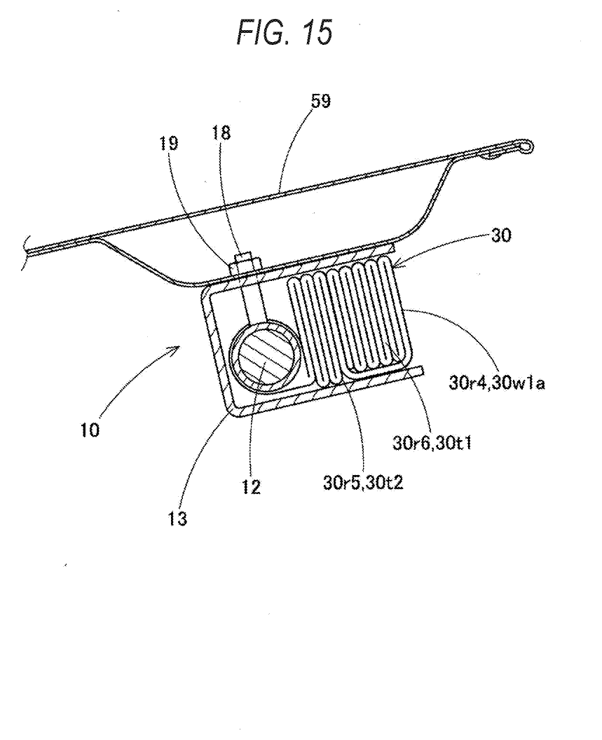

In the present embodiment, a configuration is described in which, in a folding step shown in section B of FIG. 11, the rear inflation portion 30t1 of the airbag 30 is roll-folded toward the cowl abutting portion 30w1a to form the roll-folded portion 30r3. However, a configuration may be adopted in which, as shown in FIG. 15, instead of forming the roll-folded portion 30r3 in this step, the rear inflation portion 30t1 of the airbag 30 is accordion-folded toward the cowl abutting portion 30w1a to form an accordion-folded portion 30r6, and the wound portion 30r4 is wound around the outer periphery of the accordion-folded portion 30r6.

In such a configuration, after the cowl abutting portion 30w1a is abutted against the protrusion 58x of the cowl top panel 58, the airbag 30 can also climb over the protrusion 58x when the wound portion 30r4 is deployed while rotating to release the roll-folding around the accordion-folded portion 30r6 similarly. Therefore, the airbag 30 can be prevented from being caught by the protrusion 58x of the cowl top panel 58 during the deployment.

In the first embodiment and the second embodiment, a configuration is illustrated in which the airbag 30 covers the periphery of the left end portion 58a of the cowl top panel 58 and substantially the entire region of the left front pillar 55 from above, and the airbag 40 covers the periphery of the right end portion 58b of the cowl top panel 58 and substantially the entire region of the right front pillar 56 from above. However, the present invention is not limited thereto, and shapes of the airbags 30, 40 may be changed as appropriate as long as the airbags 30, 40 are configured to at least partially cover the left front pillar 55 and the right front pillar 56 from above. Further, a connection portion that connects the airbag 30 and the airbag 40 may be provided above the cowl top panel 58 or the like, and the airbag 30 and the airbag 40 may be configured as one airbag.

What is claimed is:

1. An airbag device to be mounted on a vehicle including a front window, front pillars disposed on both sides of the front window in a left-right direction, a hood panel disposed in front of the front window, and a cowl top panel disposed between the front window and the hood panel in a front-rear direction and including a protrusion that protrudes upward, the airbag device comprising:
an airbag configured to be folded and stored inside the vehicle, in which the airbag is delivered outside the vehicle from a gap between the hood panel and the cowl top panel while being inflated and deployed by being supplied with an inflation gas, is deployed rearward to abut against and ride over the protrusion, and covers at least a part of each of the front pillars from above at a time of full inflation; and
an inflator configured to discharge the inflation gas to be supplied to the airbag, wherein
an abutting portion of the airbag that is abutted against the protrusion during the deployment from a folded state is roll-folded in a state where the airbag is folded.

2. An airbag device to be mounted on a vehicle including a front window, front pillars disposed on both sides of the front window in a left-right direction, a hood panel disposed in front of the front window, and a cowl top panel disposed between the front window and the hood panel in a front-rear direction and including a protrusion that protrudes upward, the airbag device comprising:
an airbag configured to be folded and stored inside the vehicle, in which the airbag is delivered outside the vehicle from a gap between the hood panel and the cowl top panel while being inflated and deployed by being supplied with an inflation gas, is deployed rearward to abut against and ride over the protrusion, and covers at least a part of each of the front pillars from above at a time of full inflation; and
an inflator configured to discharge the inflation gas to be supplied to the airbag, wherein
the airbag in a folded state includes:
a roll-folded portion that is roll-folded; and
a wound portion that is wound around an outer periphery of the roll-folded portion, in which a winding direction of the wound portion is opposite to a roll direction of the roll-folded portion, and
an abutting portion of the airbag that is abutted against the protrusion during the deployment from the folded state is configured as the wound portion in a state where the airbag is folded.

3. An airbag device to be mounted on a vehicle including a front window, front pillars disposed on both sides of the front window in a left-right direction, a hood panel disposed in front of the front window, and a cowl top panel disposed between the front window and the hood panel in a front-rear direction and including a protrusion that protrudes upward, the airbag device comprising:
an airbag configured to be folded and stored inside the vehicle, in which the airbag is delivered outside the vehicle from a gap between the hood panel and the cowl top panel while being inflated and deployed by being supplied with an inflation gas, is deployed rearward to abut against and ride over the protrusion, and covers at least a part of each of the front pillars from above at a time of full inflation; and
an inflator configured to discharge the inflation gas to be supplied to the airbag, wherein
the airbag in a folded state includes:
an accordion-folded portion that is accordion-folded; and
a wound portion that is wound around an outer periphery of the accordion-folded portion, and
an abutting portion of the airbag that is abutted against the protrusion during the deployment from the folded state is configured as the wound portion in a state where the airbag is folded.

4. The airbag device according to claim 1, wherein
at least a part of a front inflation portion in front of the abutting portion of the airbag at the time of full inflation is accordion-folded in the state where the airbag is folded.

5. The airbag device according to claim 2, wherein
at least a part of a front inflation portion in front of the abutting portion of the airbag at the time of full inflation is accordion-folded in the state where the airbag is folded.

6. The airbag device according to claim 3, wherein
at least a part of a front inflation portion in front of the abutting portion of the airbag at the time of full inflation is accordion-folded in the state where the airbag is folded.
